(19) United States
(12) Patent Application Publication
(10) Pub. No.: US 2003/0065617 A1
(43) Pub. Date: Apr. 3, 2003

(54) Method of billing for utilization of a data storage array, and an array controller therefor

(76) Inventors: Mark Robert Watkins, Bristol (GB); Andrew Michael Sparkes, Bristol (GB); Alastair Michael Slater, Wiltshire (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/183,956

(22) Filed: Jun. 28, 2002

(30) Foreign Application Priority Data
Oct. 3, 2001 (GB) 0116065.4

(51) Int. Cl. G06F 17/60

(52) U.S. Cl. 705/40

(57) ABSTRACT

Utilisation by hosts of a data storage array is billed by allocating to the array a number of areas to which data can be written. A table of area usage is formed for each area. An area or areas are allocated to hosts as required. In response to data being written by a host to a sector of an area, a record of used sector is written to the respective table. On the basis of the information in the area usage tables, hosts are billed for the actual level of utilisation of the allocated area or areas.

### BACKGROUND AND SUMMARY OF THE INVENTION

The invention relates to a method of billing for utilisation of data storage arrays of the kind used to store data for a number of independent end users or hosts, and a controller for data storage arrays.

It is known in the prior art for companies and other organisations with computer systems, known as hosts, to outsource the bulk storage of data from such systems to a storage service provider. These organisations obtain the benefit that they do not need to invest capital in large data storage arrays or to employ specialists to manage such arrays.

The storage service providers have large data storage arrays, and they partition their total storage capacity into areas commonly called Logical Units (LUNs), with a LUN being, when the arrays comprise hard discs as is currently the norm, a particular disc, plurality of discs or part of a particular disc. Thus a LUN has a defined physical location or set of physical locations within the data storage array.

When an organisation rents a certain volume of storage capacity for use by a host the relevant number of LUNs are assigned to that host, and the host may aggregate them into volumes. It is rare for a LUN to be used to its full capacity to store host information, as this is only true once the LUN, or volume, is full. However, once the size of a LUN is configured at the outset it is difficult to reconfigure the LUN to a larger capacity without removal and reinsertion of all the data. Such increases in capacity are generally avoided by allocating capacity at the outset to exceed predicted maximum usage requirements. Also, information technology (IT) managers tend to avoid full volumes as full volumes can cause their own problems. The net result may be a significant amount of disc space which is allocated to particular hosts, on one or more of the discs in the service provider's array, remaining unused by the respective hosts and inaccessible to other hosts. Thus an expensive resource is under utilised, but each host is generally charged for the full capacity allocated to it.

Furthermore, in recent years the storage service provider business has become very competitive, with end-users expecting to pay lower and lower amounts for the same storage capacity. Being able to provide the service in a more cost effective manner than in the prior art would give a service provider a significant advantage.

According to one aspect of the present invention, a method of enabling billing a host or hosts for their utilisation of a data storage array having allocated to it a number of areas to which data can be written, comprises:

a) forming a respective area usage table for each area;

b) allocating an area or areas to the host or hosts as required; and

c) responding to data written by a host to a sector of an area allocated to that host by writing to the respective table a record of a used sector.

On the basis of the information in the tables, the host(s) can be billed based upon the actual level of utilisation of the area or areas allocated to the hosts.

Each table may comprise entries numbered 0 to n−1 corresponding to n sectors in the respective area. In response to a sector of an area being written to, the corresponding entry in the respective table is flagged as used.

Preferably each usage table has entries only for those sectors of the respective area which are used. In response to a sector of an area being first written to, a new entry is created corresponding to that sector.

The method can include the further step of, from time to time, exporting information on the level of usage of each area from the tables to a billing module for billing of the hosts. The times at which the information is exported can be predetermined. Alternatively the times can be variable and the information is exported on demand.

The areas allocated to the disc storage array can be virtual areas.

The areas can be Logical Units (LUNS), or in the case of virtual areas, Virtual Logical Units (VLUNS).

The area usage tables are preferably stored in non-volatile memory.

According to a second aspect of the invention an array controller controls data storage in a data storage array that is divided into areas. One area is a usage table for each respective area in which a record is kept of sectors of the respective areas which have been written to. The data on the level of usage on the respective area can be exported from time to time to a billing module.

According to a third aspect of the invention a method of enabling billing for utilisation of a data storage array having allocated to it a plurality of areas of storage capacity, comprises:

a) forming a respective area usage table for each area;

b) responding to data written to a sector of an area by writing to the respective area usage table a record of a used sector; and

c) from time to time exporting information on the level of usage of the area from the table to a billing module.

The user of the area can be billed based upon the user's actual level of utilisation of the area of the data storage array.

According to a fourth aspect of the invention a method of enabling billing a user for actual utilisation of an area of storage capacity of a data storage array divided into a plurality of areas of storage capacity comprises:

a) creating a corresponding area usage table for each area;

b) responding to the user of an area writing data to a sector of the area by writing to the corresponding area usage table a record of a used sector; and

c) from time to time exporting information on the level of usage by the user of the area from the area usage table to a billing module.

The user of the area can be billed based upon the user's actual utilisation of the area of storage capacity.

According to a fifth aspect of the invention there is provided a method of obtaining information on the level of usage of a data storage array that is nominally divided into a plurality of storage capacity areas. This information is obtained without knowledge of the data format or of the data stored in the array. In this method, an area usage table is formed for each area. In response to data being written to a sector of an area, a record of a sector used is written to the respective area usage table.

According to a sixth aspect of the invention there is provided a method of obtaining information on the level of usage of a data storage array accessed remotely by a host or hosts, wherein the data storage array is nominally divided into a plurality of areas. The method is performed without knowledge of the host or hosts file systems or of the data format or of the data stored therein. The method comprises:

a) forming a respective area usage table for each area;

b) allocating to a host or hosts an area or areas as required; and

c) responding to data written by a host to a sector of an area by writing to the respective area usage table a record of a sector used.

### BRIEF DESCRIPTION OF THE DRAWINGS

Embodiments of, or operating in accordance with, the invention will now be described with reference to the accompanying drawings in which:

FIG. 1 is a schematic illustration of a prior art disc array and linked hosts,

FIG. 2 is a schematic illustration of a disc array operating in accordance with a first preferred embodiment of the invention;

FIG. 3 is a flow chart of the operation of the disc array of FIG. 2 in accordance with a preferred embodiment of the invention, and

FIG. 4 is a schematic illustration of a disc array operating in accordance with a second preferred embodiment of the invention.

### DETAILED DESCRIPTION OF THE DRAWINGS

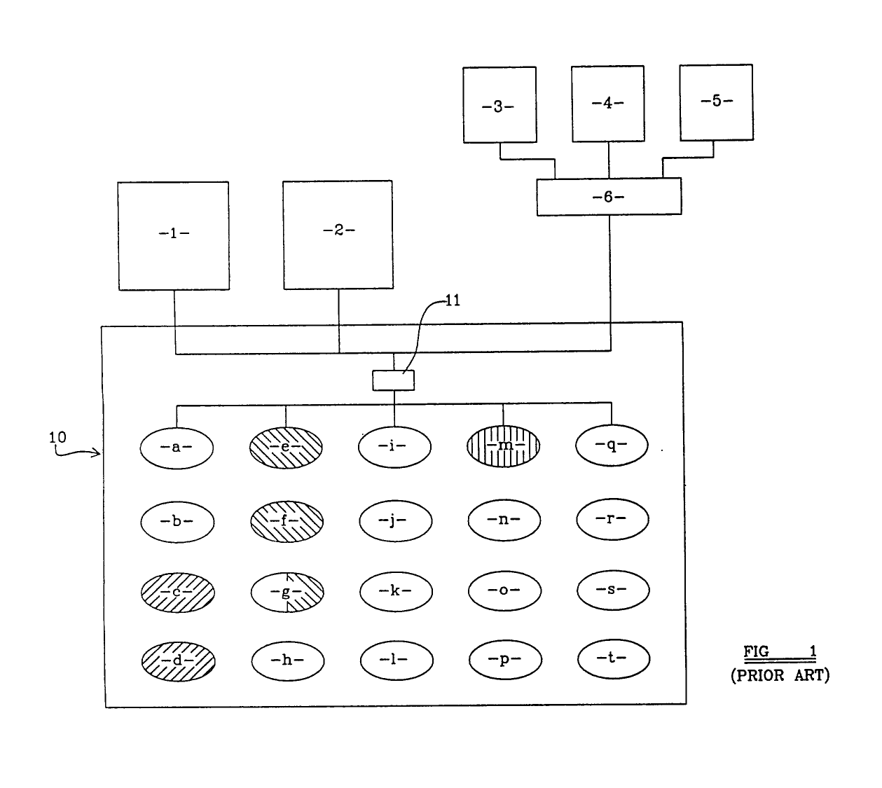

Referring first to FIG. 1, a prior art data storage array in the form of a disc array 10 is illustrated schematically. Hosts 1, 2, 3, 4 and 5 all use the disc array 10 for storage of their bulk data, hosts 1 and 2 via direct connection and hosts 3, 4 and 5 via an I/O interconnect or fibre channel switch 6 or the like. Discs a to t of the disc array 10 are divided into a plurality of physical areas, known as Logical Units or LUNs, which have physical locations on the discs a to t. Each host has part of a LUN, a LUN or a number of LUNs allocated to it depending upon their expected maximum usage requirements. So each host has allocated to it a physical area of the disc array 10; for example host 1 may have been allocated discs c and d, host 2 discs e, f and part of g, host 3 disc m, and so on. The physical area of the disc array 10 allocated to a host is accessed by use of the relevant physical addresses, using a simple array controller 11, which performs the mapping between the host LUN view and the physical disc locations.

Thus in the prior art when data are written to, or read from, the disc array 10 by a host, the array controller 11 performs a simple mapping operation for LUN sectors to read/write into physical addresses used within the disc array 10. Hence a LUN may in the prior art be considered as a contiguous array of sectors numbered 0 to n−1 (where n determines the size of the LUN).

Because each host has a particular physical space allocated to it in the system of FIG. 1, the physical space allocated to one host cannot be used by any other party. Typically each host uses only a fraction of its allocated space, and much of the space is never utilised, but the service provider has no visibility of the actual level of usage of the allocated areas by the hosts. For these reasons each host has to pay for the entire capacity allocated to it, whether used or not.

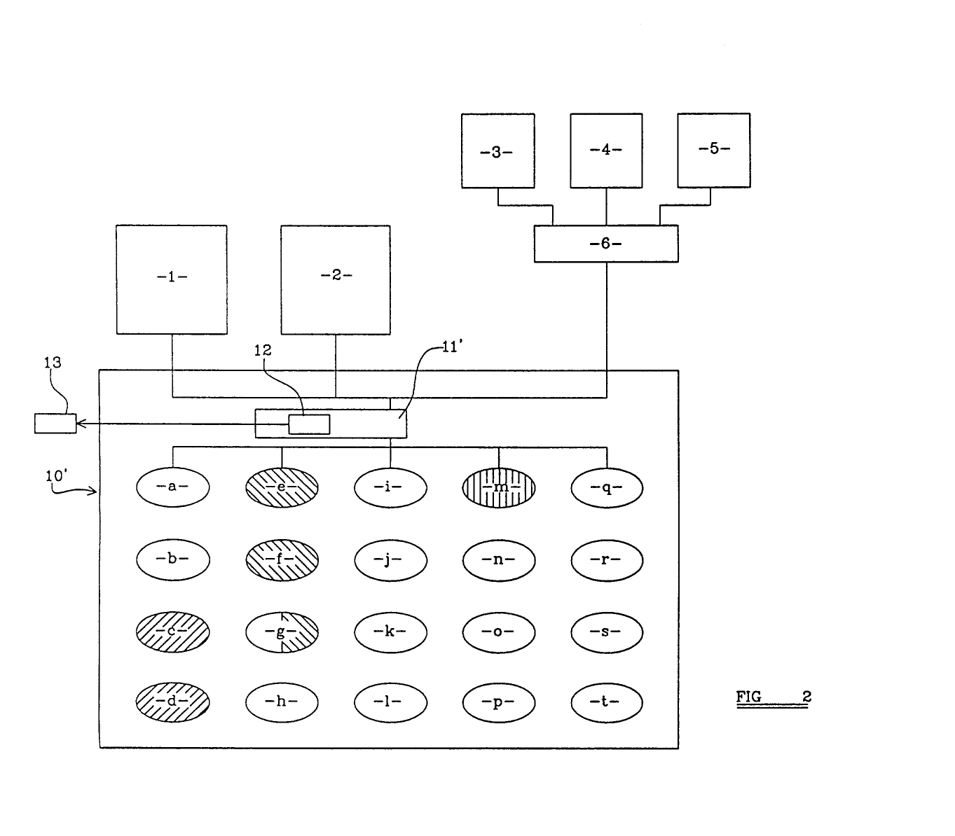

Referring now to FIG. 2, a first embodiment of a modified disc array 10′ operated according to a preferred embodiment of the invention is schematically illustrated. The disc array 10′ operates as previously described for the prior art disc array 10 with the exception of one aspect. Before making a LUN, or LUN's, available to a host, the array controller 11′ forms a LUN usage table 12 with records numbered sequentially from 0 to n−1 representing the n sectors within the LUN, or LUN's. Thereafter, in response to any request by the host to write data to any sector within the LUN(s) allocated to it, howsoever made, the array controller 11′ flags the corresponding usage table entry as consumed. The usage table 12 is stored in non-volatile memory, such that the data in it are not affected by power cycling.

At intervals the array controller 11 exports from the table 12 details of the current level of usage of a LUN or LUN's to a billing module 13 which may be on a separate host computer entity, or is interrogated by the billing module 13, depending upon the appropriate software set up. The intervals at which the information is exported may be predetermined, or the information may be exported on demand at variable time intervals. Hence, at the desired time intervals, the billing module 13 can ascertain the actual level of usage of the LUN or LUN's and invoice the host concerned based upon the capacity used rather than for the entire capacity of the LUN or LUNs allocated to the host.

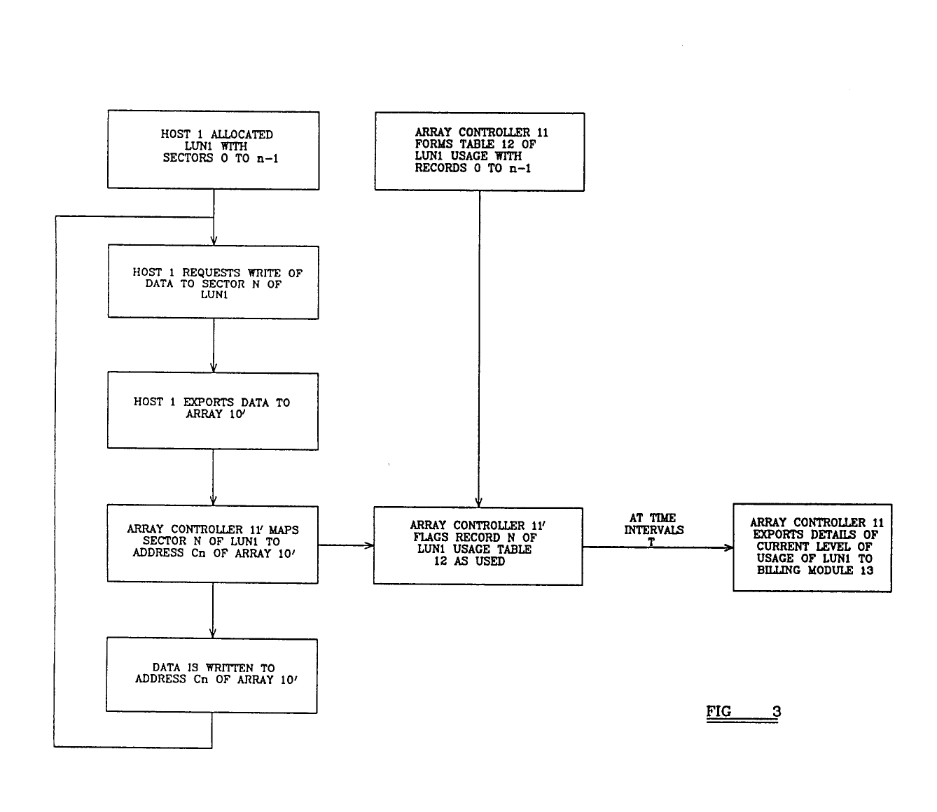

An example of the above sequence of events, for Host 1 writing to its LUN, called LUN1, is illustrated in the flow chart of FIG. 3.

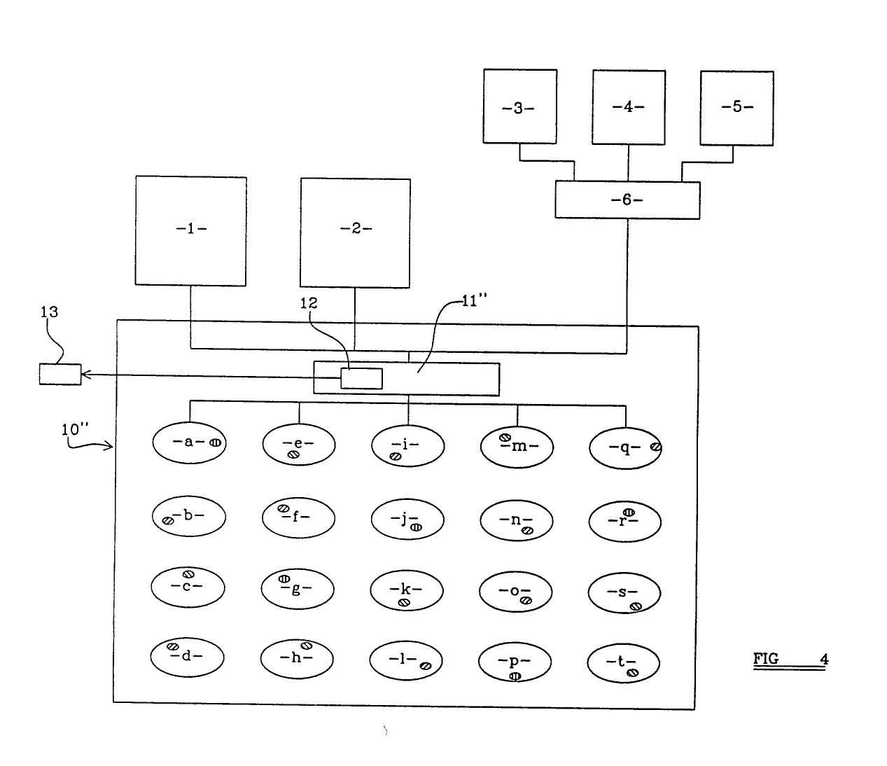

Referring now to FIG. 4, a second embodiment of a disc array 10″ operated according to a preferred embodiment of the invention, is schematically illustrated, in which the array controller 11″ operates quite differently from that in the prior art. The physical volume of the disc array 10″ is partitioned into a number of virtual areas, known conveniently as Virtual Logical Units (VLUNs), which are not allocated physical space on the discs a to t at that time. When a host requests a certain amount of storage capacity it is allocated the relevant storage capacity in terms of VLUNs.

The array controller 11″ performs a different mapping operation to that conducted in the prior art, in that it maps only those used sectors of a VLUN into physical addresses on the discs a to t. Hence when a virtual sector of a VLUN is written, the array controller 11″ allocates a free sector from the total physical storage of the disc array 10″ and allocates that physical address to the virtual address within the VLUN. The physical address is at that point considered used and allocated to the appropriate VLUN.

Thereafter, further read/write accesses to that logical sector within the VLUN are mapped to the allocated physical sector in the disc array 10″. Whenever the array controller 11′ receives a request to write data to a sector within a VLUN that is not already mapped to a physical sector in the disc array 10″, another physical sector is allocated to the relevant VLUN as described above. All VLUN addresses from 0 to n−1 can be accommodated in this fashion, but if a host never requests to write to certain addresses of the VLUN there is reduced risk that respective physical disc array resources are allocated but remain unused.

As for the embodiment of FIG. 4, before the host commences storage in the array 10″ a usage table 12 of VLUN usage by that host in established by the array controller 11″, with addresses from 0 to n−1 representing the entire capacity of the VLUN(s) allocated to the host. As and when a virtual address within a VLUN is allocated to a physical sector in the array 10″ the relevant entry in the table 12 is flagged as being consumed, and thus the level of usage of physical capacity within the array 10″ is constantly recorded. As described above, the information contained within the usage table 12 can, at required intervals, be downloaded by the array controller 11 to a billing module 13, or obtained by that billing module 13 as a result of interrogating the usage table 12. Each host can thus be charged to reflect its actual usage of physical storage space with the disc array 10″.

In the FIG. 4 embodiment, instead of a host's data being located in a contiguous physical area of disc array 10″, in a contiguous physical area, as it is in the prior art disc array 10, the host's data are dispersed around the entire disc array 10″, as shown in FIG. 4, and interspersed with the data of other hosts, although the hosts will generally notice no difference in operation from the prior art. However, the embodiment provides the advantage for a service provider that a much greater proportion of the physical space within the disc array 10″ can be used, indeed the physical space within the disc array 10″ can be filled up. Thus the expensive resource of the disc array 10″ can be fully utilised, and charged for, while providing cost effective storage for the hosts, making this embodiment particularly attractive for storage service providers.

In the above described embodiments, the usage tables 12 are formed at the outset with n (0 to n−1) records and each record is flagged as used as and when data are written to the relevant sector of the LUN or VLUN. However, this means that the each table 12 is itself occupying a large amount of memory from the outset, but with large amounts of it essentially unused.

In a preferred embodiment the usage tables do not have records 0 to n−1, but data are written to the tables, when data are first written to a particular sector N. The data written to the tables indicates that the particular sector is used. The usage tables thus grow dynamically as the usage of the LUNs or VLUNs increases, and no unnecessary storage capacity is occupied by them. The tables, at any specific time, have an accurate record of the level of utilisation of the LUNs or VLUNs. That information can be exported and used as previously described.

The systems and methods associated with FIGS. 2-4 provide the advantage that the actual amount of data stored within a given LUN or LUN's can be monitored without need for the service provider to have knowledge of the volume manager, or file system, of which it may be part. Indeed, it is not normally the case that service providers would have such information made available to them as all information concerning the operating systems, file structure etc., is held by the hosts and not by the service provider.

The invention is described in conjunction with a data storage array in the form of a disc array, in which the discs will typically be the kind of storage medium generally referred to as hard discs. However, the invention is equally applicable to other forms of data storage array using other storage media, such as magnetic RAM (MRAM), optical storage and solid state storage.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of enabling billing a host or hosts for their utilisation of a data storage array having allocated to it a number of areas to which data can be written, the method comprising the steps of:
a) forming a respective table of area usage for each area;
b) allocating an area or areas to the host or hosts as required; and
c) responding to data written by a host to a sector of an area allocated to the host by writing to the respective table a record of a used sector.

2. The method of claim 1, further including billing the host(s) based upon the actual level of utilisation of the area or areas allocated to them on the basis of the information in the tables.

3. A method according to claim 1 wherein each table has entries numbered 0 to n−1, corresponding to n sectors in the respective area, and responding to a sector of an area being written to by flagging the corresponding entry in the respective table as used.

4. A method according to claim 1 wherein each table has entries only for those sectors of the respective area which are used, and responding to a sector of an area being first written to, by creating a new entry in the respective table corresponding to that sector.

5. A method according to claim 1 further including from time to time exporting information on the level of usage of each area from the tables to a billing module for billing of the host(s).

6. A method according to claim 5 wherein the times at which information is exported are predetermined.

7. A method according to claim 5 wherein the times at which information is exported are variable, the information being exported on demand.

8. A method according to claim 1 wherein the areas allocated to the data storage array are virtual areas.

9. A method according to claim 1 wherein the areas allocated to the data storage array are Logical Units (LUNS).

10. A method according to claim 8 wherein the virtual areas are Virtual Logical Units (VLUNs).

11. A method according to claim 1 wherein the tables are stored in nonvolatile memory.

12. An array controller for the control of data storage in a data storage array, the data storage array being divided into areas, the array controller including an area usage table for each respective area in which a record is kept of sectors of the respective area which have been written to, and from which data on the level of usage of each area are exported at intervals to a billing module.

13. An array controller according to claim 12 wherein each area usage table has entries numbered 0 to n−1, where an area has n sectors, and responding to a sector of an area being written to by flagging the corresponding entry in the respective area usage table as used.

14. An array controller according to claim 12 wherein each area usage table only has entries corresponding to the sectors of the respective area which are used, and responding to a sector of an area being first written to by creating a new entry in the respective area usage table corresponding to that sector.

15. An array controller according to claim 12 wherein the data on the level of usage of each area are exported at predetermined intervals.

16. An array controller according to claim 12 wherein the areas are virtual areas.

17. A method of enabling billing for utilisation of a data storage array having allocated to it a plurality of areas of storage capacity, comprising the steps of:
a) forming a respective area usage table for each area;
b) responding to data written to a sector of an area by a user of said area by writing to the respective area usage table a record of a used sector; and
c) from time to time exporting information on the level of usage of said area from the area usage table to a billing module.

18. The method of claim 17 further comprising billing the user of said area based upon the user's level of utilisation of the area of the data storage array.

19. A method of enabling billing a user for actual utilisation of an area of storage capacity of a data storage array divided into a plurality of areas of storage capacity, comprising the steps of:
a) creating a corresponding area usage table for each area;
b) responding to the user of an area writing data to a sector of said area by writing to the corresponding area usage table a record of a used sector; and
c) from time to time exporting information on the level of usage by the user of said area from the area usage table to a billing module.

20. A method according to claim 19 further including billing the user of said area based upon the user's actual utilisation of the area of storage capacity.

21. A method of obtaining information on the level of usage of a data storage array nominally divided into a plurality of areas of storage capacity, the method being performed without knowledge of the data format or of the data stored therein, comprising the steps of:
a) forming a respective area usage table for each area; and
b) responding to data being written to a sector of an area by writing to the respective area usage table a record of a sector used.

22. A method according to claim 21 wherein the area usage tables are located in the data storage array.

23. A method according to claim 22 wherein the method further includes the step of from time to time exporting from the area usage tables information on the level of usage of the areas of the data storage array.

24. A method according to claim 21 wherein the area usage tables are stored in non-volatile memory.

25. A method of obtaining information on the level of usage of a data storage array nominally divided into a plurality of areas and accessed remotely by a host or hosts, the method being performed without knowledge of the host or hosts file systems or of the data format or of the data stored in the array, comprising the steps of:
a) forming a respective area usage table for each area;
b) allocating to a host or hosts an area or areas as required; and
c) responding to data written by a host to a sector of an area by writing to the respective area usage table a record of a sector used.
